(19) United States
(12) Patent Application Publication
(10) Pub. No.: US 2012/0194296 A1
(43) Pub. Date: Aug. 2, 2012

(54) SIMULTANEOUS PHASE AND AMPLITUDE CONTROL USING TRIPLE STUB TOPOLOGY AND ITS IMPLEMENTATION USING RF MEMS TECHNOLOGY

(76) Inventors: Mehmet Unlu, Ankara (TR); Simsek Demir, Ankara (TR); Tayfun Akin, Ankara (TR)

(21) Appl. No.: 13/496,255

(22) PCT Filed: Sep. 15, 2009
(86) PCT No.: PCT/TR09/00116

§ 371 Date: Apr. 18, 2012

(51) Int. Cl. H01P 1/18

(52) U.S. Cl. 333/156

(57) ABSTRACT

This invention relates to techniques for controlling the amplitude and the insertion phase of an input signal in RF applications. More particularly, this invention relates to phase shifters, vector modulators, and attenuators employing both semi-conductor and RF microelectromechanical systems (MEMS) technologies.

### RELATED FIELD OF THE INVENTION

This invention relates to techniques for controlling the amplitude and the insertion phase of an input signal in RF applications. More particularly, this invention relates to phase shifters, vector modulators, and attenuators employing both semiconductor and RF microelectromechanical systems (MEMS) technologies.

### BACKGROUND OF THE INVENTION (PRIOR ART)

Insertion phase and amplitude control components are crucial for microwave and millimeterwave electronic systems. Phase shifters and vector modulators are most widely used components for this purpose. These components are employed in a number of applications that include phased arrays, communication systems, high precision instrumentation systems, and radar applications.

The phase shifters are basically designed in two types, which are analog and digital controlled versions. The analog phase shifters, as the name refers, are used for controlling the insertion phase within 0-360° by means of varactors. The digital phase shifters are used for producing discrete phase delays, which are selected by means of switches.

The following list includes the publications and the patents that presents basic examples of the prior art related to this invention:

1. W. E. Hord Jr, C. R. Boyd, and D. Diaz, “A new type of fast-switching dual-mode ferrite phase shifter,” IEEE Trans. Microwave Theory Tech., vol. 35, no. 12, pp. 1219-1225, December 1987.

2. M. J. Schindler and M. E. Miller, “A 3-bit K/Ka band MMIC phase shifter,” IEEE Microwave and Millimeter-Wave Monolithic Circuits Symp. Dig., New York, N.Y., USA, 1988, pp. 95-98.

3. A. W. Jacomb-Hood, D. Seielstad, and J. D. Merrill, “A three-bit monolithic phase shifter at V-band,” IEEE Microwave and Millimeter-Wave Monolithic Circuits Symp. Dig., June 1987, pp. 81-84.

4. S. Weinreb, W. Berk, S. Duncan, and N. Byer, “Monolithic varactor 360° phase shifters for 75-110 GHz,” Int. Semiconductor Device Research Conf. Dig., Charlottesville, Va., USA, December 1993.

5. R. V. Garver, “Broad-Band Diode Phase Shifters,” IEEE Trans. Microwave Theory Tech., vol. 20, no. 5, pp. 312-323, May 1972.

6. G. M. Rebeiz, RF MEMS: Theory, Design, and Technology. John Wiley & Sons, 2003.

7. A. Malczewski, S. Eshelman, B. Pillans, 1 Ehmke, and C. L. Goldsmith, “X-Band RF MEMS phase shifters for phased array applications,” IEEE Microwave Guided Wave Lett., vol. 9, no. 12, pp. 517-519, December 1999.

8. G. L. Tan, R. E. Mihailovich, J. B. Hacker, J. F. DeNatale, and G. M. Rebeiz, “Low-Loss 2- and 4-Bit TTD MEMS phase shifters based on SP4T switches,” IEEE Trans. Microwave Theory Tech., vol. 51, no. 1, pp. 297-304, January 2003.

9. N. S. Barker and G. M. Rebeiz, “Distributed MEMS true-time delay phase shifters and wideband switches,” IEEE Trans. Microwave Theory Tech., vol. 46, no. 11, pp. 1881-1890, November 1998.

10. J. S. Hayden and G. M. Rebeiz, “Very low loss distributed X-band and Ka-band MEMS phase shifters using metal-air-metal capacitors,” IEEE Trans. Microwave Theory Tech., vol. 51, no. 1, pp. 309-314, January 2003.

11. G. B. Norris, D. C. Boire, G. St. Onge, C. Wutke, C. Barratt, W. Coughlin, and J. Chickanosky, “A fully monolithic 4-18 GHz digital vector modulator,” IEEE Int. Microwave Symp. Dig., Dallas, Tex., USA, May 1990, pp. 789-792.

12. L. M. Devlin and B. J. Minnis, “A versatile vector modulator design for MMIC,” IEEE Int. Microwave Symp. Dig., Dallas, Tex., USA, May 1990, pp. 519-521.

13. A. E. Ashtiani, S. Nam, A. d'Espona, S. Lucyszyn, and I. D. Robertson, “Direct multilevel carrier modulation using millimeter-wave balanced vector modulators,” IEEE Trans. Microwave Theory Tech., vol. 46, no. 12, pp. 2611-2619, December 1998.

14. R. Pyndiah, P. Jean, R. Leblanc, and J. C. Meunier, “GaAs monolithic direct linear (1-2.8) GHz QPSK modulator,” 19th European Microwave Conf. Dig., London, UK, September 1989, pp. 597-602.

15. I. Telliez, A. M. Couturier, C. Rumelhard, C. Versnaeyen, P. Champion, and D. Fayol, “A compact, monolithic microwave demodulator-modulator for 64-QAM digital radio links,” IEEE Trans. Microwave Theory Tech., vol. 39, no. 12, pp. 1947-1954, December 1991.

16. U.S. Pat. No. 3,454,906 (Bisected Diode Loaded Line Phase Shifter)

17. U.S. Pat. No. 3,872,409 (Shunt Loaded Line Phase Shifter)

18. U.S. Pat. No. 5,832,926 (Multiple Bit Loaded Line Phase Shifter)

19. U.S. Pat. No. 6,356,166 B1 (Multi-Layer Switched Line Phase Shifter)

20. U.S. Pat. No. 6,542,051 B1 (Stub Switched Phase Shifter)

21. U.S. Pat. No. 6,281,838 B1 (Base-3 Switched-Line Phase Shifter Using Micro Electro Mechanical (MEMS) Technology)

22. U.S. Pat. No. 6,741,207 B1 (Multi-Bit Phase Shifters Using MEM RF Switches)

23. U.S. Pat. No. 6,958,665 B2 (Micro Electro-Mechanical System (MEMS) Phase Shifter)

24. U.S. Patent Application No. 2006/0109066 A1 (Two-Bit Phase Shifter)

25. U.S. Pat. No. 7,068,220 B2 (Low Loss RF Phase Shifter with Flip-Chip Mounted MEMS Interconnection)

26. U.S. Pat. No. 7,157,993 B2 (1:N MEM Switch Module)

27. U.S. Patent Application No. 2009/0074109 A1 (High Power High Linearity Digital Phase Shifter)

28. U.S. Pat. No. 6,509,812 B2 (Continuously Tunable MEMS-Based Phase Shifter)

29. U.S. Pat. No. 7,259,641 B1 (Microelectromechanical Slow-Wave Phase Shifter Device and Method)

30. U.S. Patent Application No. 2008/0272857 A1 (Tunable Millimeter-Wave MEMS Phase-Shifter)

31. U.S. Pat. No. 4,806,888 (Monolithic Vector Modulator/Complex Weight Using All-Pass Network)

32. U.S. Pat. No. 4,977,382 (Vector Modulator Phase Shifter)

33. U.S. Pat. No. 5,093,636 (Phase Based Vector Modulator)

34. U.S. Pat. No. 5,168,250 (Broadband Phase Shifter and Vector Modulator)

35. U.S. Pat. No. 5,355,103 (Fast Settling, Wide Dynamic Range Vector Modulator)

36. U.S. Pat. No. 5,463,355 (Wideband Vector Modulator which Combines Outputs of a Plurality of QPSK Modulators)

37. U.S. Pat. No. 6,531,935 B1 (Vector Modulator)

38. U.S. Pat. No. 6,806,789 B2 (Quadrature Hybrid and Improved Vector Modulator in a Chip Scale Package Using Same)

39. U.S. Pat. No. 6,853,691 B1 (Vector Modulator Using Amplitude Invariant Phase Shifter)

There are three main technologies for the implementation of phase shifters, which are ferrite phase shifters, semiconductor based (PIN or FET based) phase shifters, and MEMS based phase shifters. Ferrite phase shifters have low insertion loss, good phase accuracy, and they can handle high power. However, they are bulky, they require a large amount of DC power, and they are slow compared to their rivals [Above list item: 1]. FET based [2], PIN based [3], and varactor diode based [4] phase shifters are the semiconductor alternatives for phase shifters. They propose low cost, low weight, and planar solutions to phased array systems. PIN based phase shifters provide lower loss compared to the FET based ones; however, they consume more DC power.

The phase shifters are implemented in several different topologies. These include reflection-type, switched-line, loaded-line [5], varactor/switched-capacitor bank, and switched network topologies. In all of these digital topologies (except varactor based one), the switching components are FETs or PIN diodes. Since the insertion losses of these components are high, the overall insertion losses of the phase shifters are also high. The reported insertion losses are about 4-6 dB at 12-18 GHz and 7-10 dB at 30-100 GHz [6].

RF MEMS phase shifters became strong alternatives for semiconductor based phase shifters, provided that the application area is limited to relatively low scanning arrays. A number of phase shifters are demonstrated that employ the above mentioned topologies [7], [8]. The reported average insertion losses of these designs vary between −1 and −2.2 dB, which are much lower than that of the semiconductor based designs.

Distributed phase shifters that employ RF MEMS varactors have also been presented [9] for very wide-band applications up to 110 GHz. Examples of the phase shifters using both analog [9] and digital [10] topologies are presented, and the reported insertion loss is about at most −2.5 dB up to 60 GHz [6].

A number of above mentioned phase shifters have been patented up to date. Examples of loaded line and stub loaded phase shifters are presented in patents [16]-[20] that use different types of switches, mainly diodes. Phase shifter that employ MEMS technology are also presented in a number of patents. Examples of digital and analog phase shifters can be found in patents [21]-[27] and [28]-[30], respectively.

Vector modulators are employed in phased arrays, in which they are used for controlling the amplitude and the insertion phase of each antenna element. Moreover, vector modulators are used in digital communication systems where they are used for the direct modulation of the carrier signal. With the usage of these components, IF stage is removed from a heterodyne transceiver, which results with much lower complexity and cost of the system.

The vector modulators are generally designed in two types, which are the cascaded (or α-φ) modulator and the I-Q modulator. The α-φ modulator consists of a cascade connection of an attenuator and a phase shifter. The I-Q modulator divides the input power into two orthogonal vectors so that any vector can be obtained by applying phase and amplitude control on these vectors, and finally, by combining them. The α-φ vector modulators were first presented by Norris et al. [11], and Devlin et al. [12] presented the first I-Q type vector modulator.

The I-Q modulators are usually implemented using two topologies. The first topology employs quadrature power splitters with balanced reflective terminations as variable resistances (Ashtiani et al. [13]). The second topology employs mixers, in which the local oscillator (LO) is divided into two orthogonal components. These components are modulated by means of two mixers, and finally, they are combined by means of combiners, amplifiers, couplers, etc. (Pyndiah et al. [14], Tellliez et al. [15]).

The above mentioned vector modulators have also been patented in the last two decades, the main examples of which can be found in [31]-[39].

Examples of both of these topologies are presented using several semiconductor technologies, which include HBT, CMOS, and pHEMT. However, no passive vector modulators are presented up to date.

### BRIEF DESCRIPTION OF THE INVENTION

The present invention relates to a novel method of using the well-known triple stub topology. In particular, the invention makes it possible to control both the insertion phase and the amplitude of an input signal simultaneously with the above mentioned triple stub topology. The topology is composed of three stubs that are delimited by two transmission lines of the same length, which are the interconnection lines. The stubs are simply open or short circuited low-loss transmission lines. However, any passive or active reactive loads can be used as stubs.

According to a first aspect of the invention, the triple stub topology is used as a fixed phase shifter, which controls the insertion phase of an input signal; a fixed attenuator, which controls the amplitude of an input signal; or a fixed vector modulator, which controls both the insertion phase and the amplitude of an input signal simultaneously. The triple stub topology can be realized with two fixed-length, low-loss transmission lines as the interconnection lines; and three fixed stubs that can be implemented with any passive reactive loads such as fixed value inductors or capacitors, open or short circuited transmission lines of fixed length.

According to a second aspect of the invention, a method of realizing reconfigurable phase shifter, attenuator, or vector modulator using the triple stub topology is presented. This is achieved by changing the electrical length of the three stubs and the two interconnection lines by means of Radio Frequency Micro-Electro-Mechanical Systems (RF MEMS) components [6]. RF MEMS switches are used for controlling the electrical length in discrete steps which results with reconfigurable components with digital operation steps, i.e., 3-bit phase shifter, 3-bit attenuator, or vector modulator with 3-bit phase and amplitude resolution. RF MEMS varactors are also used for controlling the electrical lengths continuously which results with continuous operation. With this method, 0-360° continuous phase shifter, reconfigurable 0 to −6 dB continuous attenuator, and vector modulator that provides above mentioned continuous insertion phase and amplitude ranges is implemented. In addition to these, the electrical lengths of the three stubs and the two interconnection lines are controlled with distributed MEMS transmission lines (DMTLs) ([9], [10]). In this case, DMTLs are used for either analog control [9] or digital control [10] of the electrical lengths. In the latter case, quasi-continuous operation is also possible for both the insertion phase and the amplitude provided that each unit section of the DMTLs are controlled digitally and independently. For this case, 1° phase resolution is possible with ±1° phase error, and less than 0.2 dB amplitude resolution is possible with ±0.1 dB amplitude error.

According to a third aspect of the invention, novel IQ-divider, 1:k adjustable power divider, and vector modulator topologies are implemented using the triple stub topology. The triple stub topology is capable of making Zₒ-to-kZₒ real impedance transformation while controlling the insertion phase and the amplitude of an input signal. Connecting one of the ports of the two triple stub topologies together while using the remaining port of them for the outputs, a three-port network is obtained where the power ratio on the two output ports are controlled. Meanwhile, the insertion phases on the two arms are also controlled, which makes it possible to implement an IQ-divider or a 1:k adjustable ratio power divider. The same technique, i.e., connecting two triple stub topologies as described above, is used for implementing vector modulators. Here, the two arms are used for controlling the adjustable power division with adjustable insertion phase, and the output is obtained either using an inphase combiner or terminating one of the arms with matched load.

As a result, novel phase shifter, attenuator, IQ-divider, 1:k adjustable power divider, and vector modulators are obtained using triple stub topology. These circuits can be implemented as either analog or digital controlled circuits. According to a preferred embodiment of the present invention, these circuits are realized using RF MEMS components, particularly DMTLs. The related circuits provide linear phase shift versus frequency in a limited instantaneous bandwidth; however, circuits are completely reconfigurable, and ultra wide operational bandwidth can easily be obtained. For example, it is easy to obtain a 0-360° phase shifter with 10% operational bandwidth that works continuously from 15 GHz to 40 GHz.

According to a preferred embodiment, the advantages brought of the present invention are low-cost, very low insertion loss, high linearity, linear phase shift versus frequency, and broadband operation with in-situ switchable bandwidth. Although the preferred embodiment is implemented using RF MEMS technology, the present invention can be easily integrated to existing state-of-the-art semiconductor technologies.

### DEFINITION OF THE FIGURES

The present invention will be understood and appreciated more completely from the following detailed description of the drawings. The list of the figures and their explanations are as follows:

FIG. 1 shows the schematic of the triple stub topology in general according to the present invention;

FIG. 2 shows a preferred embodied schematic of the triple stub topology of the present invention in general, which employs only low-loss transmission lines;

FIG. 3 shows the schematic of a possible reconfigurable implementation of the triple stub topology with series RF MEMS switches, which can be used as a phase shifter, an attenuator, or a vector modulator;

FIG. 4 shows the schematic of a possible reconfigurable implementation of the triple stub topology with shunt RF MEMS switches, which can be used as a phase shifter, an attenuator, or a vector modulator;

FIG. 5 shows the schematic of a possible reconfigurable implementation of the triple stub topology with RF MEMS varactors, which can be used as a phase shifter, an attenuator, or a vector modulator;

FIG. 6 shows the schematic of a possible reconfigurable implementation of the triple stub topology with distributed MEMS transmission lines (DMTLs), which can be used as a phase shifter, an attenuator, or a vector modulator;

FIG. 7 shows the block diagram of the IQ adjustable power divider, which is a novel application of the invention;

FIG. 8 shows the block diagram of the 1:k adjustable power divider, which is another novel application of the invention;

FIG. 9 shows the block diagram of the vector modulator type I, which is another novel application of the invention;

FIG. 10 shows the block diagram of the vector modulator type II, which is another novel application of the invention.

### DETAILED DESCRIPTION OF THE INVENTION

From this point on, the drawings that are listed above will be referred for more comprehensible understanding of the preferred embodiment of the invention and not for limiting same.

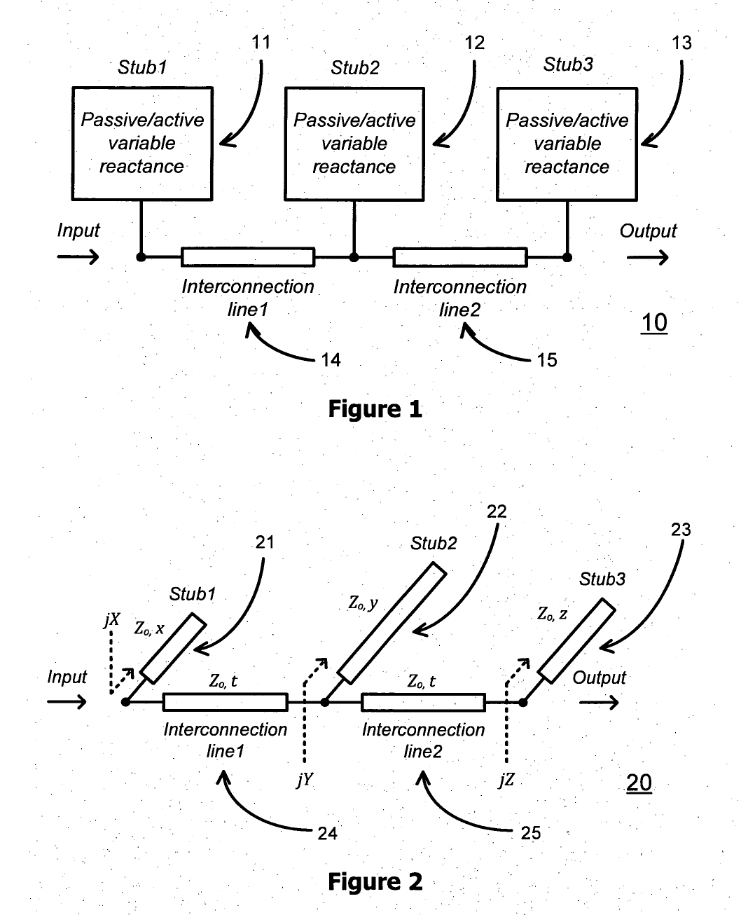

FIG. 1 shows the schematic of the triple stub topology in general, which is previously known to be used as an impedance tuning network. The topology is composed of three stubs that are delimited by two transmission lines of the same length, which are the interconnection lines. The topology is still used as an impedance tuning network, by which the match load is transformed into any real impedance, i.e., Zₒ-to-kZₒ where k is real and 0<k<∞. However, since two stubs and one interconnection line are sufficient for this transformation, the addition of the third stub results with infinitely many solutions of the problem. Among these solutions, there always exist solutions for any desired value of the insertion phase between 0-360°, which means that the insertion phase of the triple stub topology can be controlled. In this solution, the values of the susceptances of the three stubs, 21, 22, and 23, are found for any value of insertion phase between 0-360° for a fixed length of the interconnection lines, 24 and 25. This is true for any electrical length value of the interconnection line between 0°<φ<360° at the center design frequency provided that all the transmission lines are lossless.

A phase shifter that is perfectly matched at its input is obtained if the triple stub topology is set for Zₒ-to-Zₒ transformation. In this case, 22, 23, and 25 are used for the insertion phase control; 21 and 24 are used for completing Zₒto-Zₒ impedance transformation. According to a preferred embodiment, transmission lines are used for the interconnection lines, and open or short circuited transmission lines are used as stubs, which is presented in FIG. 2. Alternatively, any active or passive reactive loads can be employed as stubs.

The above mentioned analysis and design of the phase shifter is based on lossless transmission lines. However, the design is always possible in the presence of losses provided that the solution may not be possible for some values of the electrical length of the interconnection lines.

The presented phase shifter has linear phase versus frequency behavior in around 20% around the center frequency of the design. However, the input matching limits the performance around minimum 10% bandwidth of the center frequency of the design.

It is also possible to control the amplitude of the input signal, i.e., the insertion loss, simultaneously together with the insertion phase control using the triple stub topology. This means that the input signal can be controlled as a vector, and a vector modulator is obtained as a novel application of the invention. The insertion loss control is achieved as follows:

It was explained above that the triple stub topology can be used as a phase shifter, and solutions can be found for the susceptances of the stubs for any electrical length value of the interconnection line. When lossy transmission lines are used for the stubs and the interconnection lines, which is the real life situation, solutions can be found for the susceptances of the stubs for some range of the electrical length value of the interconnection lines. However, the problem has still infinitely many solutions. When the length of the interconnection lines is selected such that the sum of the lengths of 21, 22, and 24 or 22, 23, and 25 is about λ/2 at the center design frequency, it is observed that the insertion loss characteristics has peaks around the center design frequency. By tuning the interconnection line length, the insertion loss of the triple stub topology is controlled while the insertion phase value is preserved and the input is kept as perfectly matched. This is nothing but controlling the insertion phase and the insertion loss simultaneously, which is the expected response of a vector modulator.

The presented vector modulator can be easily used for changing the insertion phase between 0-360° and the insertion loss between −0.8 dB and −20 dB at 15 GHz. Higher insertion loss levels up to −30 dB are also possible; however, the input return loss of the vector modulator starts to deviate from the match condition. For higher frequencies, −20 dB value can be pushed further to higher insertion loss values; however, the minimum insertion loss value also increases. It should be essentially pointed out here that the presented vector modulator uses only low-loss transmission lines, and the above mentioned insertion loss values can be obtained for any non-zero attenuation constant of the transmission lines.

The presented vector modulator has also linear phase versus frequency behavior in around 20% around the center frequency of the design. The insertion loss characteristic of the vector modulator is flat within the same bandwidth for low-insertion loss levels. However, insertion loss starts to limit the bandwidth as the desired insertion loss value is increased. As an example, the bandwidth of the vector modulator is 1.5% at 15 GHz when an insertion loss level of −9 dB is required

The invention can also be used as an attenuator whose insertion phase is controlled considering the above analysis.

The proposed applications of the invention, i.e., the phase shifter, the attenuator, and the vector modulator, can be employed in an ultra wide band by design starting from RF frequencies up to sub-THz frequencies. According to a preferred embodiment, any 3D or planar transmission lines or waveguide structures such as coaxial lines, rectangular waveguides, microstrip lines, coplanar waveguides, striplines, etc. can be used for implementing the stubs and the interconnection lines of the invention.

The applications of the invention that are presented up to now are all fixed value networks. In other words, the above mentioned phase shifter is actually a fixed value delay line, the attenuator is a fixed value attenuator, and the vector modulator transforms the input vector to a fixed value output vector. The essential novelty that is brought by the invention is obtained when these networks are implemented as reconfigurable networks. If the electrical lengths of the stubs and the interconnection lines of the triple stub topology are somehow adjusted, reconfigurable phase shifters, attenuators, and vector modulators are obtained.

The electrical lengths of the stubs and the interconnection lines of the triple stub topology can be controlled using switches, varactors, or any other tunable active/passive components. According to a preferred embodiment, Radio Frequency Micro-Electro-Mechanical Systems (RF MEMS) components are employed as control elements. RF MEMS switches offer low insertion loss, high isolation, and high linearity, which are very critical for a preferred embodiment of the invention. This is because a high number of switches are connected in cascade in the embodiment. RF MEMS switches offer less than 0.2 dB insertion loss at 50 GHz and above, which make them feasible for these applications of the invention. The switches, varactors, or any other tunable active/passive control components can also be used within the invention provided that they have low insertion loss, high isolation, and high linearity; otherwise, the implementation of the invention is still possible with a reduced performance.

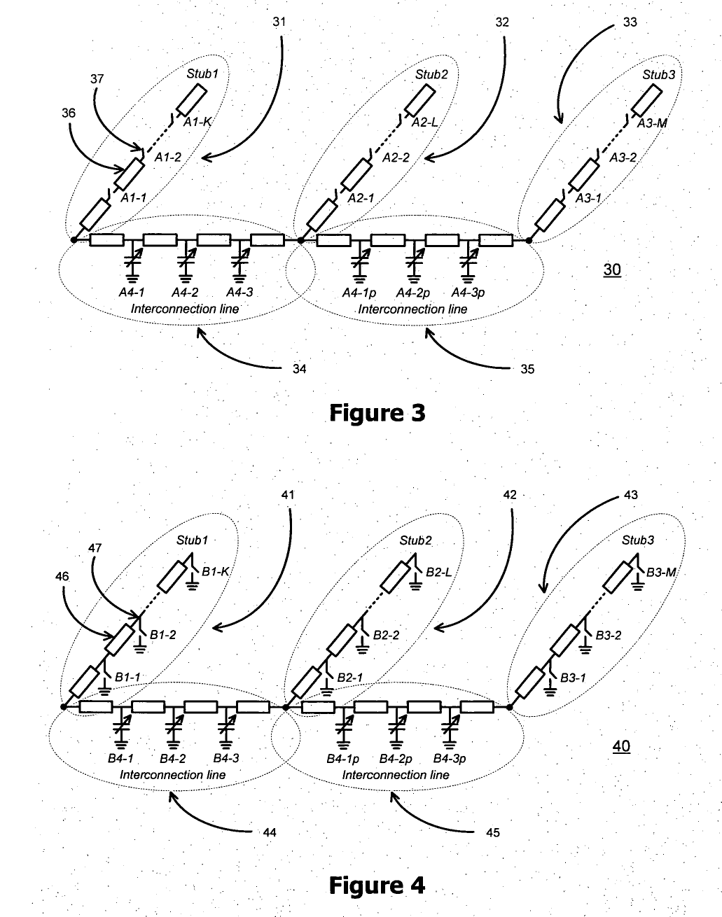

There are a number of methods to implement reconfigurable phase shifter, attenuator, or vector modulator using the triple stub topology that is presented in this invention. The first method employs RF MEMS switches for digital insertion phase and amplitude control. In this method, series or shunt RF MEMS switches are used as shown in FIG. 3 and FIG. 4, respectively. The switches here are used to control the electrical lengths of the stubs by actuating the closest switch to the required electrical lengths. The electrical lengths of the interconnection lines are also needed to be changed for the proper operation of the above mentioned reconfigurable networks. As it is not convenient to use RF MEMS switches here, RF MEMS varactors or digital capacitors are used for controlling the electrical lengths of the interconnection lines. For this implementation of the invention, one should need as many RF MEMS switches on each stub as the number of states of the design. As an example, if a reconfigurable 3-bit phase shifter is required, then one should use 8 switches on each stub, which are used for each phase state of the design and are controlled independently. The number of required different electrical lengths of the interconnection lines is always less than the number of phase states. As a result, 8 RF MEMS switches are needed on each stub, which make a total of 24 switches, and at most 3 RF MEMS digital capacitors are needed for each interconnection line. In each phase state, one switch on each stub and one combination of the digital capacitors on both interconnection line should be actuated together, which means that one control for each phase state is sufficient for the operation. So, the number of controls of the design is as many as the number of phase states for the switches on the stubs plus the total number of controls for RF MEMS capacitors on the interconnection lines, and this is 8+3 for the above example. This number can also be reduced by simply employing a multiplexer.

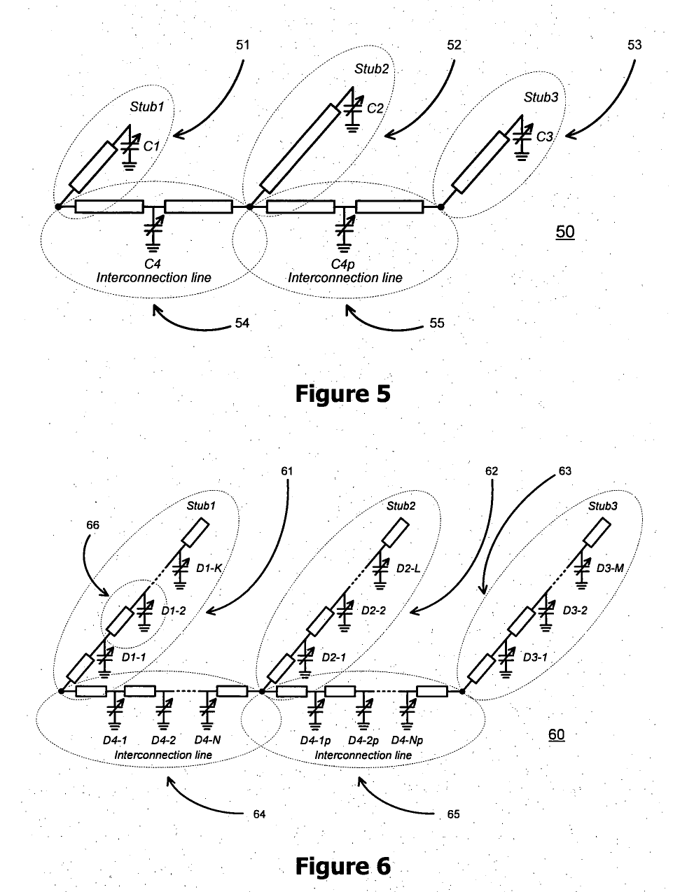

In the second method, the triple stub topology is used as analog, reconfigurable phase shifter, attenuator, or vector modulator. The schematic of the application of the invention is presented in FIG. 5. In this case, 3 RF MEMS varactors are placed at the end of each stub, and 2 RF MEMS varactors are placed on the interconnection lines. The varactors on the interconnection lines should be controlled together, and the total number of controls is 4 in this case. As the capacitance of RF MEMS varactors are controlled in an analogue manner, the electrical lengths of the stubs and the interconnection lines are also controlled in an analogue manner, which results with analog control of the insertion phase and the amplitude. The drawback here is the limited tuning range of the RF MEMS varactors. The insertion phase and the amplitude ranges are dependent upon the range provided by the varactors; however, these ranges can be extended by connecting multiple varactors in parallel.

In the third method, the triple stub topology is used as quasi-analog reconfigurable phase shifter, attenuator, or vector modulator with digital control. The schematic of the application of the invention is presented in FIG. 6 where the stubs and the interconnection lines of the triple stub topology are implemented using distributed MEMS transmission lines, namely DMTLs. DMTLs are generally used either in an analog manner by tuning the capacitance of the MEMS switches by an analog control voltage or digitally by using the MEMS switches as a switching element between two capacitors. According to a preferred embodiment of the application of the invention, DMTLs are used as the stubs where each unit section of the DMTLs is controlled independently and used as a two-state digital capacitor. Since only the input susceptances of the stubs are important for the operation of the triple stub topology, the aim here is to obtain a high number of susceptances that are obtained from the up-down combinations of the DMTL unit sections and cover a wide range of susceptance values. If n RF MEMS switches are used in a stub, then the stub can provide 2ⁿ susceptance values. According to the same embodiment, the interconnection lines are also implemented as DMTLs. These DMTLs are used similar to the ones in the digital phase shifters where they are actuated in groups and each group provide different amount of phase difference. The required number of controls for the DMTL interconnection lines is not as many as that of the stubs. As an example, if 9 DMTL unit sections are used in each stub and 8 DMTL unit sections are used in each interconnection line, a vector modulator that has 1° phase resolution with ±1° phase error and less than 0.2 dB amplitude resolution with ±0.1 dB amplitude error is possible at 15 GHz. The insertion phase range is 0-360° and the amplitude range is −2 dB to −8 dB for this vector modulator. The vector modulator has a total of 3×9=27 controls on the stubs plus a total of 5 controls for both of the interconnection lines, which makes totally 32 control for the vector modulator.

In the fourth method, the triple stub topology is used as analog, reconfigurable phase shifter, attenuator, or vector modulator, the schematic of which is also presented in FIG. 6. This is nothing but the same implementation of the third method; however, the unit sections of the DMTLs of the stubs and interconnection lines are controlled in groups, and with analogue voltages. In this case, the electrical lengths of the stubs and interconnection lines are controlled continuously, which results with a analog, reconfigurable phase shifter.

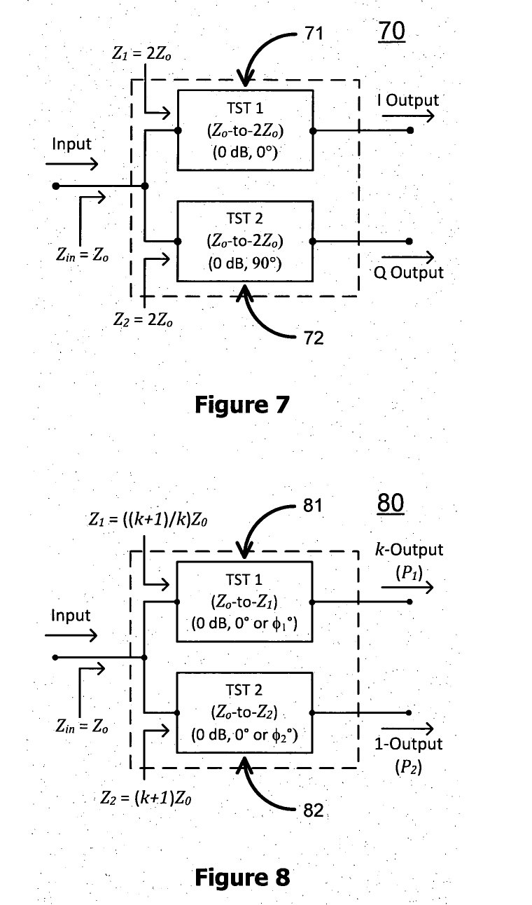

Other than the reconfigurable phase shifter, the attenuator, and the vector modulator, the invention has some other novel applications, which use two triple stub topologies. The first application is an IQ power divider, the block diagram of which is presented in FIG. 7. It was explained previously that the triple stub topology is capable to making any real-to-real impedance transformation (Zₒ-to-kZₒ, k is real and 0<k<∞) while controlling the insertion phase and the amplitude. So, if 71 is adjusted such that it transforms Zₒ-to-2Zₒ, while keeping the insertion phase as 0° (i.e., 360°) and if 72 is adjusted such that it transforms Zₒ-to-2Zₒ while changing the insertion phase as 90°, an equal power divider with 90° phase difference at its outputs is obtained connecting the inputs of 71 and 72 in parallel and taking the outputs from the outputs of 71 and 72. This is nothing but an IQ power divider.

The second novel application of the invention is a 1:k adjustable ratio power divider, the block diagram of which is presented in FIG. 8. This application is similar to the previous one; however, the usage of the triple stub topologies is different. In this case, if 81 is adjusted such that it transforms Zₒ-to-(k+1)/kZₒ and 82 is adjusted such that it transforms Zₒ-to-(k+1)Zₒ, then output power is divided k-to-1 ratio at the outputs of 81 and 82, respectively. The insertion phases of 81 and 82 can be both set as either 0° or any desired insertion phase values, φ₁° and φ₂°, respectively. As a result, the outcoming circuit is a 1:k adjustable power divider.

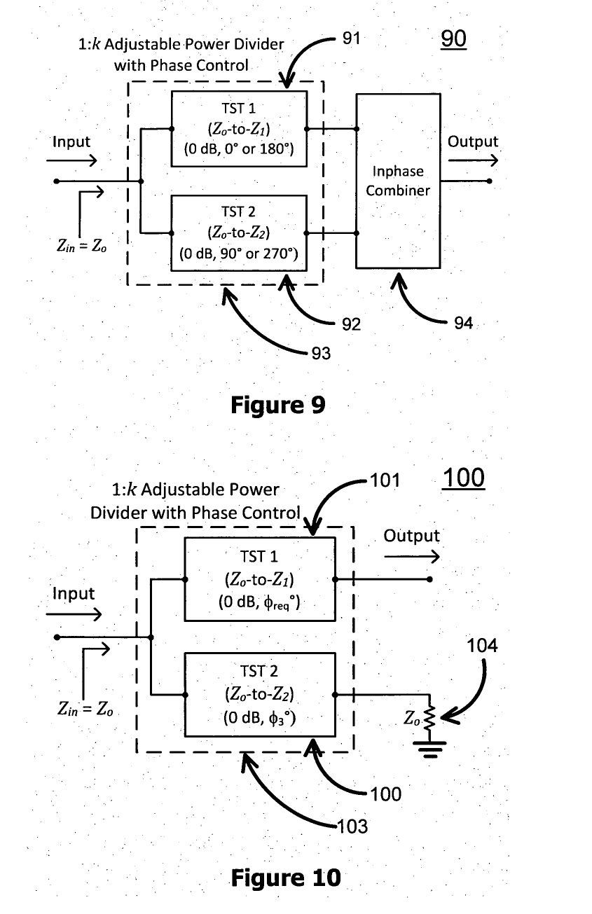

The third novel application of the invention is a vector modulator, and its block diagram is presented in FIG. 9. The idea here is to obtain four basis vectors, arrange their magnitudes, and combine them in order to obtain the desired vector, which is the method used in a standard vector modulator. The novel vector modulator employs a 1:k adjustable power divider (93), which is explained above, to obtain the basis vectors, and the magnitudes and the insertion phases of the vectors are inherently adjusted using the power divider. The first triple stub topology, 91, in the power divider is set such that the insertion phase is either 0° or 180°, which is used to obtain inphase or out of phase basis vectors. The second triple stub topology, 92, in the power divider is set such that the insertion phase is either 90° or 270°, which is used to obtain the quadrature basis vectors. The outputs of the triple stub topologies are combined by means of an inphase combiner (84) as in FIG. 9.

An alternative vector modulator topology is presented in FIG. 10, which drops the necessity for the inphase combiner. This topology also employs a 1:k adjustable power divider (93); however, the insertion phases of the triple stub topologies are set differently. The first triple stub topology, 101, in the power divider is set to the desired insertion phase, and the output of the vector modulator is taken from the output of this arm. The insertion phase of the second triple stub topology, 102, in the power divider can be set to any value, and the output of this arm is terminated with a matched load, 104.

The advantage that is brought by the two latter vector modulator circuits, which use two triple stub topologies, over the former one, which use a single triple stub topology, is the operational bandwidth. As explained previously, the bandwidth of the former circuit decreases as the required amplitude level decreases. However, for the two latter circuits, the power ratio is adjusted by dividing the power into two arms, and hence, the two triple stub topologies are always operated for high amplitude levels. So, the bandwidths of the latter circuits are almost the same as that of the above mentioned phase shifter that uses a single triple stub topology.

For all of the four novel circuit topologies presented as applications of the invention, the employed triple stub topologies can be implemented using the four methods that are explained previously. These methods are using RF MEMS switches (FIG. 3 and FIG. 4), RF MEMS varactors (FIG. 5), and distributed MEMS transmission lines, DMTLs (FIG. 6).

1. A reconfigurable phase shifting, amplitude, and impedance tuning circuit that is implemented using the triple stub topology, comprising: three or more stubs that are used as loading elements and have adjustable electrical lengths; and two or more transmission lines/waveguides that connect the stubs and have adjustable electrical lengths; and wherein phase shifting, amplitude control, and impedance tuning is obtained simultaneously.

2. The circuit of claim 1, wherein the transmission lines/waveguides that are used in the circuit are implemented using planar structures such as coplanar waveguides, microstrip lines or 3D structures such as coaxial lines, rectangular waveguides, circular waveguides, striplines, and the adjustability of electrical lengths of the stubs and interconnection lines are realized by means of plurality of passive components, such as MEMS components such as (switches, varactors, digital capacitors), or plurality of active components such as PIN diodes, FET transistors, bipolar transistors.

3. The circuit of claim 2, wherein the MEMS components are either fabricated monolithically with the transmission lines/waveguides, or fabricated independently, and then, placed on the transmission lines/waveguides and connected by means such as wirebonds, ribbons, soldering or welding.

4. The circuit of claim 1, wherein the whole circuit is implemented in a monolithic fabrication process.

5. The circuit of claim 1, wherein the circuit is realized as a analog, digital, or quasi-analog circuit depending on how the adjustability of the electrical lengths of the stubs and interconnection lines are realized.

6-153. (canceled)
